(19) United States
(12) Patent Application Publication
(10) Pub. No.: US 2003/0148539 A1
(43) Pub. Date: Aug. 7, 2003

(54) Micro fabricated fountain pen apparatus and method for ultra high density biological arrays

(75) Inventors: R. Michael van Dam, Pasadena, CA (US); Stephen R. Quake, San Marino, CA (US); Axel Scherer, Laguna Beach, CA (US); Matthew O. Reese, New Haven, CT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA (US)

(21) Appl. No.: 10/288,248

(22) Filed: Nov. 4, 2002

Related U.S. Application Data
(60) Provisional application No. 60/338,720, filed on Nov. 5, 2001.
(60) Provisional application No. 60/364,202, filed on Mar. 14, 2002.

(51) Int. Cl. B01L 3/02; G01N 1/10

(52) U.S. Cl. 436/180; 422/58; 422/100; 216/2

(57) ABSTRACT

A fluid dispensing system for at least biological applications, e.g., oligonucleotides, peptide nucleic acids (“PNA”), proteins, polysaccharides, polypeptides, inorganic solutions, microelectromechanical systems (MEMS), optical sensors, and other applications. The dispensing system includes a fluid dispensing apparatus for applying selected fluids in a predetermined manner to form a plurality of spots based upon one or more of the selected fluids on a surface of a substrate. The apparatus comprises an elongated member having at least a tip portion, which extends from the elongated member. The apparatus also has an etched trench extending along a portion of a length of the elongated member to the tip to form an opening defined on the tip portion and coupled to the etched trench. A flexible region is defined within the elongated member to allow the tip to adjust in position upon contact with the surface of the substrate. A fluid is disposed within the etched trench. The fluid is output through the opening on the tip to form more than one spots on the surface of the substrate.

### CROSS-REFERENCES TO RELATED APPLICATIONS

This application claims priority to U.S. Provisional Nos. 60/338,720 filed Nov. 5, 2001 and 60/364,202 filed Mar. 24, 2002, commonly assigned, and which are incorporated by reference herein.

### BACKGROUND OF THE INVENTION

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

The present invention relates generally to biological arrays. More particularly, the invention includes an apparatus and method for selectively distributing fluid using a novel dispensing apparatus. Merely by way of example, the invention is applied to cDNA species in an array configuration on a substrate, but it would be recognized that the invention has a much broader range of applicability. For example, the invention can be applied to oligonucleotides, peptide nucleic acids (“PNA”), proteins, polysaccharides, polypeptides, inorganic solutions, microelectromechanical systems (MEMS), optical sensors, and other applications.

DNA microarrays have become powerful tools for analysis of many biological and medical problems. Such problems range from tumor typing (Golub et al. 1999, Alizadeh et al. 2000) to reverse engineering biological circuits and pathways (DeRisi et al. 1997, Chu et al. 1998, Lockhart and Winzeler 2000) Exhibit 1 which is incorporated by reference, provides a list of references cited herein. High density DNA microarrays have been produced via one of many technologies: photolithographic DNA synthesis, modified ink-jet systems, or precisely controlled robotic pens. While the photolithographic technique (Lipshutz et al. 1999) can produce feature sizes as small as 18 microns, it has drawbacks that include high cost and limited oligonucleotide length. Furthermore, since about 10-20 different probes are needed for reliable detection of each gene, commercial arrays have thus far been limited to about 19,500 transcripts on a 1.28×1.28 cm square chip (12,000 genes/cm²) (http://www.affymetrix.com/support/technical/datasheets/hgu133_datasheet.pdf). More efficient chemistry has been employed in the ink-jet method for in situ synthesis, resulting in longer oligos which have sufficient specificity to uniquely detect genes. Though feature sizes are larger, arrays of 25,000 spots on 25×75 mm glass slides have been reported (Shoemaker et al. 2001). Techniques for the deposition of cDNA or synthetic oligonucleotides, including bubble jet printers and robotically controlled pens, are capable of producing features as small as 70×75 microns (Okamoto et al. 2000, http://www.majerprecision.com/pins.htm, http://arrayit.com/Products/Printing/Stealth/stealth.html). To our knowledge, the largest reported deposition array contains 82,944 spots in a 18 mm×72 mm area, corresponding to a density of 6400 genes/cm² (http://arrayit.com/Products/Printing/Stealth/stealth.html).

Other approaches include dispensing biological materials using fountain pens. Conventional fountain pens for cDNA arrayers have been machined by hand. Such pens used stainless steel or titanium rods first ground to a sharp tip, and then a slot is cut in the tip. Miniature grinding wheels and saws were used to cut early slots, but most commercial pen manufacturers now use wire EDM (electrical discharge machining) or laser cutting methods to achieve slots as small as 10-40 microns in width (http://www.majerprecision.com/pins.htm, http://arrayit.com/Products/Printing/Stealth/stealth.html, http://www.biorobotics.com/Pages/micspot.html). Unfortunately, many limitations have been uncovered using such fountain pens. As merely an example due to the precision grinding and machining each pen requires, they have been generally expensive and often difficult to make. Cost has also been an important consideration in micro array systems because the pens are often used in multiplexed print heads of 16, 32 or even 48 pens.

The dominant factor in spot size tends not to be the slot width, but rather the much larger contact area of the pen with the substrate (Reese 2001). However, as pens shrink, practical problems arise. Sharper tips become less durable due to dulling by repeated tapping, and narrower slots suffer from clogging and rapid sample evaporation. There are many other limitations as well, which are described throughout the present specification and more particularly below.

From the above, it is seen that techniques for forming biological microarrays are highly desirable.

### BRIEF SUMMARY OF THE INVENTION

According to the present invention, techniques for forming biological arrays are provided. More particularly, the invention includes an apparatus and method for selectively distributing fluid using a novel dispensing apparatus. Merely by way of example, the invention is applied to cDNA species in an array configuration on a substrate, but it would be recognized that the invention has a much broader range of applicability. For example, the invention can be applied to oligonucleotides, peptide nucleic acids (“PNA”), proteins, polysaccharides, polypeptides, inorganic solutions, microelectromechanical systems (MEMS), optical sensors, and other applications.

In a specific embodiment, the present invention provides a fluid dispensing system for biological applications, e.g., oligonucleotides, peptide nucleic acids (“PNA”), proteins, polysaccharides, polypeptides, inorganic solutions and/or other applications such as microelectromechanical systems (MEMS), optical sensors, and the like. The dispensing system includes a fluid dispensing apparatus for applying selected fluids (e.g., cDNA, oligonucleotides, peptide nucleic acids (“PNA”), proteins, polysaccharides, polypeptides, inorganic solutions) in a predetermined manner to form a plurality of spots based upon one or more of the selected fluids on a surface of a substrate. The apparatus comprises an elongated member having at least a tip portion, which extends from the elongated member. The apparatus also has an etched trench extending along a portion of a length of the elongated member to the tip to form an opening defined on the tip portion and coupled to the etched trench. A flexible region is defined within the elongated member to allow the tip to adjust in position upon contact with the surface of the substrate. A fluid is disposed within the etched trench. The fluid is output through the opening on the tip to form more than one spots the surface of the substrate.

In an alternative specific embodiment, the invention provides a method for forming a high density array of spots on a substrate for biological applications. The method includes providing a dispensing apparatus, which has an elongated member having at least a trench region that extends from a first portion of the elongated member to an opening on a tip portion. The method applies the tip to a surface of the substrate at an angle whereupon the angle ranges from about 20 to 30 degrees from a position normal to the surface of the substrate. The method also dispenses fluid through the trench region that extends from the first portion of the elongated member to the opening at the tip to form a fluid region having a size of a dimension substantially equal to a width of the opening of the trench.

In alternative specific embodiments, the invention provides a method for manufacturing a fountain pen dispenser for biological applications. The method includes providing a substrate, which has an upper surface, a bottom surface, and a thickness defined therebetween. The method also forms a trench region within the substrate from the upper surface. The method patterns the bottom surface of the substrate to define an elongated member from the substrate. Alternatively, the bottom surface and upper surface may be patterned together or the upper surface only may be patterned to define the elongated member from the substrate. The elongated member has the trench region defined therein, whereupon the trench region extends from an upper portion to a lower portion of the elongated member along a length of the elongated member. The method includes etching a portion of the bottom surface to free the tip and substantially define the elongated member, while maintaining support of the elongated member via a support structure formed between the elongated member and an outer region of the substrate. The method also includes coating a portion of the trench region including the opening with a hydrophilic material. Other ways of patterning can also be used. Such ways include laser ablation, etc. or any combination of these, depending upon the application.

Still further, the invention provides a biological array of spots having a quantity to map a complete human genome (or other genome) on a single substrate. The biological array has a substrate including a surface and a thickness. Preferably, the surface has a hydrophillic characteristic, which has a dimension variation from a first end to a second end by about ten or tens of microns in certain embodiments. At least 100,000 spots are provided on a surface of the substrate. Each of the spots is placed in a spatial manner based upon a predetermined order. At least two of the spots are separated by at pitch no greater than sixty microns and at least two of the spots include a characteristic length no greater than sixty microns. Preferably, each of the spot sizes is about 30 microns and less, depending upon the application. Preferably, the complete human genome is provided on the single substrate to reduce a possibility of variation between the substrate and another substrate. In certain embodiments, only one spot of cDNA is required to detect a gene. Other types of genomes (e.g., mouse, bacteria, virus) can also be detected. Specific embodiments include spot sizes of less than 5 microns or even 1 micron in dimension. To achieve 100,0000 spots on a 18 millimeter by 72 millimeter portion of an array, pitch size should be less than 114 microns or a density of at least 7,700 genes (spots)/cm².

In yet an alternative embodiment, the invention includes a method for manufacturing a fountain pen dispenser. The method includes providing a substrate, which has a top surface, a bottom surface, and a thickness defined between the top surface and bottom surface. The method also includes patterning the top surface of the substrate to define a trench region having a length and width. The method forms an elongated member having the trench region defined therein from the substrate. The elongated member has a tip portion coupled to an opening of the trench region. Preferably, fluid is provided in the trench and and outputted from the opening.

Numerous benefits are achieved using the present invention over conventional techniques, depending upon the embodiment. The present invention provides for microfabrication techniques using conventional chemicals and processes. As merely an example, stainless steel microfabrication techniques are used (Dziurdzia et al. 2000, Matson 1999) to make fountain pens with controlled features and geometry. High precision and resolution of microfabrication allow one to design pens with small slot widths and contact areas, yet large reservoirs to prevent evaporation. Such pens can be manufactured cheaply and in high volumes and their resolution surpasses that of the best hand machined pens, allowing a considerable increase in array density. We used our pens in a robotic array system to deposit spots that are10-30 microns wide and 20-140 microns long, an improvement over conventional techniques. Arrays were created with densities as high as 25,000 spots/cm². Carryover during array printing was tested with dye, labeled DNA, and hybridized DNA and found to be indistinguishable and identifiable from background. Multiple successful hybridizations demonstrated that hybridization experiments are indeed possible on the droplets deposited, with negligible carryover and good sequence specificity. High density microarrays that may fit an entire genome on a single slide are desirable for a number of reasons, including sensitivity, cost, convenience and controlling experimental error due to variation between slides. Arrays that could accommodate multiple replicates of each gene are also desirable to increase data quality, especially for genes expressed at very low levels (Jin et al. 2001). Preferably, the invention achieves an ability to spot cDNA at high densities (e.g., at least 7,700 spots (genes)/cm²). Preferably, the invention allows for multiple (more than one) copies of the same gene on a single slide, which allows for improved control over the analysis. Depending upon the embodiment, one or more of these benefits may be achieved. These and other benefits are provided throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a fluid dispensing apparatus according to an embodiment of the present invention;

FIG. 2 is a simplified diagram of a fluid dispensing apparatus according to an alternative embodiment of the present invention;

FIG. 3 illustrates simplified diagrams of a fluid dispensing method according to an embodiment of the present invention;

FIG. 4 illustrates methods of fabricating a fluid dispensing apparatus according to an embodiment of the present invention; and

FIGS. 5-9 are simplified diagrams of experimental results according to embodiments of the present invention

### DETAILED DESCRIPTION OF THE INVENTION

According to the present invention, techniques for forming biological arrays are provided. More particularly, the invention includes an apparatus and method for selectively distributing fluid using a novel dispensing apparatus. Merely by way of example, the invention is applied to cDNA species in an array configuration on a substrate, but it would be recognized that the invention has a much broader range of applicability. For example, the invention can be applied to oligonucleotides, peptide nucleic acids (“PNA”), proteins, polysaccharides, polypeptides, inorganic solutions, microelectromechanical systems (MEMS), optical sensors, and other applications.

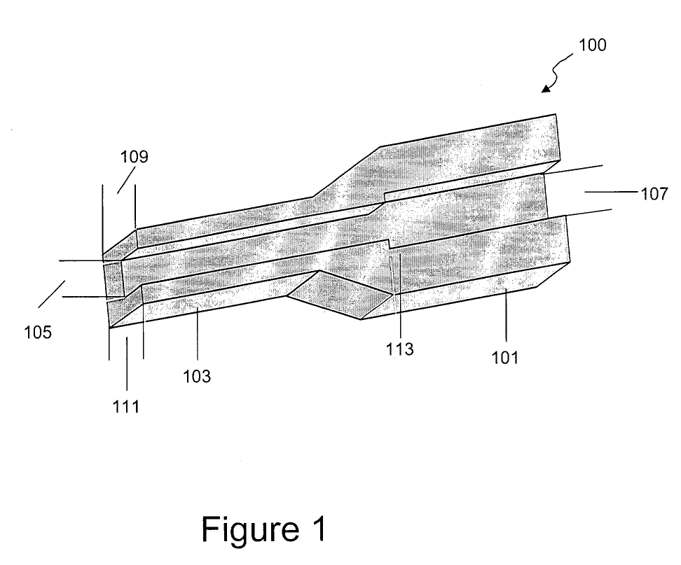

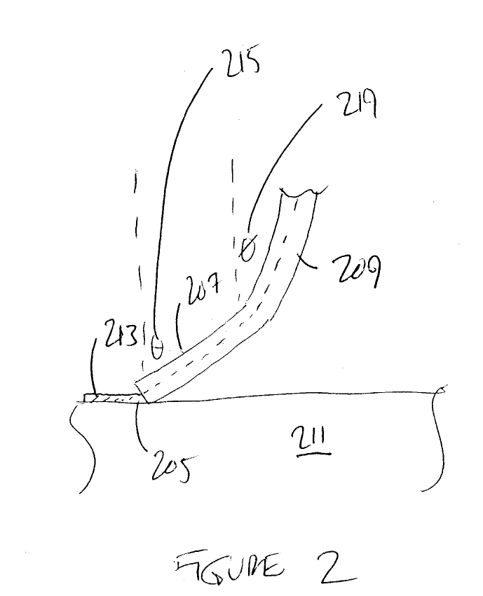

FIG. 1 is a simplified diagram of a fluid dispensing apparatus 100 according to an embodiment of the present invention. This diagram is merely an example, which should not unduly limit the scope of the claims herein. One of ordinary skill in the art would recognize many other variations, modifications, and alternatives. As shown, the dispensing apparatus 100 is for applying selected fluids (e.g., cDNA, oligonucleotides, peptide nucleic acids (“PNA”), proteins, polysaccharides, polypeptides, inorganic solutions) in a predetermined manner to form a plurality of spots based upon one or more of the selected fluids on a surface of a substrate. The apparatus comprises an elongated member 101, 103 having at least a tip portion 109, which extends from the elongated member. The tip portion 109 includes an opening 105. Fluid is dispensed from the opening.

Additionally, the apparatus has an etched trench 107 extending along a portion of a length of the elongated member to the tip to form the opening 105 defined on the tip portion and coupled to the etched trench. The etched trench portion is larger in width than the tip portion. The etched trench portion can be used as a fluid reservoir or the like. Depending upon the embodiment, the width is larger by about two times or more. Additionally, a depth of the etched trench 107 can also be deeper than the tip portion. As also shown, the tip is a continuous region with a positive annular region to form the opening. The tip portion includes at least three sides, including a bottom region, coupled to a pair of sides. An opening is defined along a region opposing the bottom region. The apparatus would experience less evaporation of fluid than conventional devices, which use only two sides and are open along two other sides in a trapezoidal structure. The apparatus also includes elongated portion 103, which is also a flexible region defined within the elongated member to allow the tip to adjust in position upon contact with the surface of the substrate. The fluid is disposed within the etched trench, which has a first region 113 and a second region on elongated portion 103. The first region is characterized by a first width and depth and the second region is characterized by a second width and depth. In a specific embodiment, the first width and depth are respectively the same as the second width and depth. Preferably, the first width is smaller than the second width to form a larger volume region in the second region. Preferably, the width is about 6 microns and less, depending upon the embodiment. The depth is about 30 microns and less, also depending upon the embodiment. Preferably, the depth of the trench is about 6 microns and less and the elongated member has a thickness of less than 12.7 microns from an upper region to a lower region. The fluid is output through the opening on the tip to form more than one spots on the surface of the substrate. Preferably, the apparatus and tip can be used to hold a single solution or fluid.

In a specific embodiment, the elongated member is made of a suitable material. Preferably, the material is rigid but can undergo small deflections in response to force. Preferably, the material has flexible characteristics near the tip portion as well as other portions. In a specific embodiment, the elongated member is made of stainless steel to allow the tip to adjust in position upon contact with a surface of the substrate. The trench region is also etched and has a hydrophilic coating overlying exposed surfaces of the etched trench. In certain embodiments, the etched trench comprises an overlying layer of urethane, but can also be made of other materials. Of course, one of ordinary skill in the art would recognize many other variations, alternatives, and modifications.

As noted, fluid is dispensed from the opening. The fluid can include biological materials, inorganic solutions, e.g., combinatorial chemistry, among other materials. In some embodiments, the fluid has a density that is about 1, which is similar to water. Alternatively, the density of the fluid can be any suitable material that flows, depending upon the application. The fluid can also be conductive or non-conductive. The conductive fluid can be a salt and a surfactant. Further details of the invention can be found throughout the present specification and more particularly below.

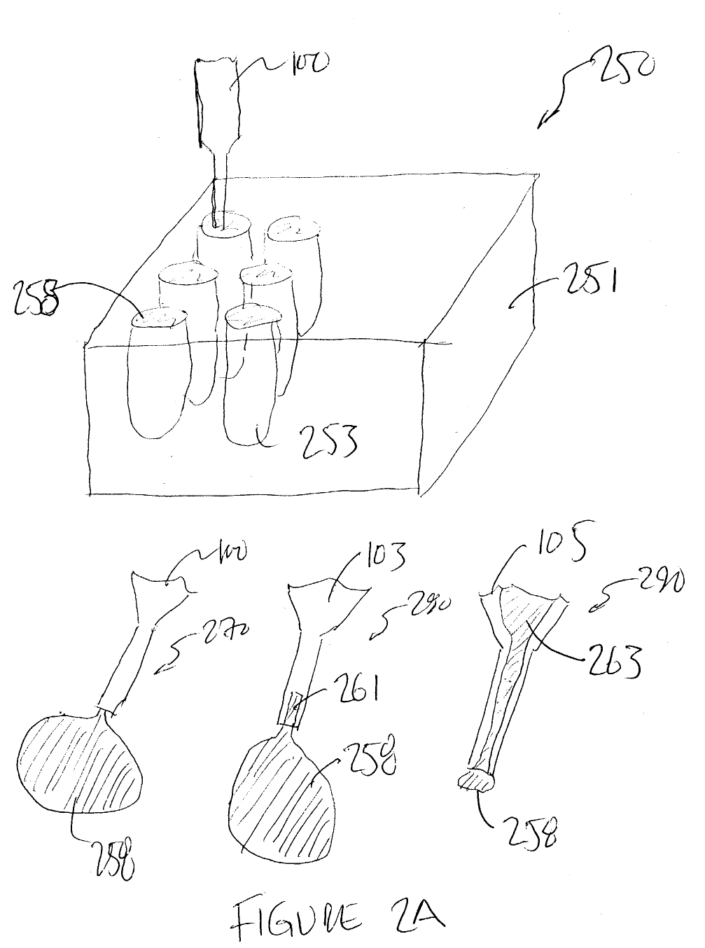

FIG. 2 is a simplified diagram of a fluid dispensing apparatus 201 according to an alternative embodiment of the present invention. This diagram is merely an example, which should not unduly limit the scope of the claims herein. One of ordinary skill in the art would recognize many other variations, modifications, and alternatives. As shown, the dispensing apparatus has tip portion, including end 205. The end includes an opening defined on the end of the trench portion 207, which extends into the elongated member. Such elongated member may be similar to the one noted above, but can be others. The opening is applied toward a surface of substrate 211. A spot 213 is formed on the substrate. A plurality of spots are applied to the substrate using the dispensing apparatus. The apparatus also has another portion 209, which couples to the tip portion. The other portion holds fluid and acts as a reservoir, depending upon the embodiment. Depending upon the embodiment, the tip portion may be applied at a first angle theta 215, which is larger than the end portion, which adjusts at another angle 219, which is smaller. The first angle is larger than the second angle. The tip portion bends at angles that are greater than the end portion in most embodiments. Additional details of the present apparatus for obtaining and applying fluid are provided throughout the present specification and more particularly below.

According to a specific embodiment, a method for obtaining fluid to fill an apparatus with fluid according to an embodiment of the present invention is outlined as follows:

1. Provide a dispensing apparatus, which has an elongated member having at least a trench region that extends from a first portion of the elongated member coupled to an opening on a tip portion to a second portion, which is a reservoir;

2. Apply the tip to a fluid supply;

3. Transfers fluid through the opening of the trench region that extends from the first portion of the elongated member using capillary action;

4. Transfer fluid from the first portion to the second portion, which is the reservoir, while the fluid continues to transfer into the first portion from the opening, using capillary action;

5. Lift the tip from the fluid supply;

6. Move the apparatus to a substrate to transfer the fluid to form spots; and

7. Perform other steps, include forming other spots on the substrate, as desired.

The above sequence of steps provides a method of obtaining fluid for the apparatus. The method can be used for form a high density array of spots for biological materials. Preferably, the spots have a dimension and characteristic to allow for the entire human genome, which could include at least 30,000 spots, depending upon the application. Further details of the method are provided with reference to the figure below.

Referring to FIG. 2A, the method 250 includes providing a dispensing apparatus 100, which has an elongated member having at least a trench region that extends from a first portion of the elongated member coupled to an opening on a tip portion to a second portion, which is a reservoir. The dispensing apparatus can be similar to the one noted above or others, which are within the scope of the claims herein. The method applies the tip to a fluid supply 258. Preferably, a plurality of tips are applied to the fluid in parallel, where each tip can be for an apparatus. Additionally, the fluid can be from any one of the fluid regions, which may include different fluids depending upon the application. The fluid supply can be any suitable fluid supply device such as a microtiter plate 251 or the like, which has a plurality of supply regions 253.

Preferably, the method transfers fluid 270 through the opening of the trench region that extends from the first portion of the elongated member using capillary action 261. The method also transfers 280 fluid from the first portion to the second portion 103, which is the reservoir, while the fluid continues to transfer 263 into the first portion from the opening, using capillary action. The method lifts the tip 290 from the fluid supply. Depending upon the embodiment, the method moves the apparatus to a substrate to transfer the fluid to form spots and performs other steps, include forming other spots on the substrate, as desired. Further details of a method for forming spots in an array is provided throughout the present specification and more particularly below.

According to a specific embodiment, a method for forming a high density array of spots on a substrate for biological applications is outlined as follows:

1. Provide a dispensing apparatus, which has an elongated member having at least a trench region that extends from a first portion of the elongated member to an opening on a tip portion;

2. Apply the tip to a surface of the substrate at an angle;

3. Maintain the angle at ranges from about 20 to 30 degrees from a position normal to the surface of the substrate;

4. Transfers fluid through the trench region that extends from the first portion of the elongated member to the opening at the tip;

5. Form a fluid region having a size of a dimension substantially equal to a width of the opening of the trench;

6. Lift the tip from the surface of the substrate;

7. Move the tip to another spatial region of the substrate;

8. Apply the tip at an angle from the substrate;

9. Form another fluid region having a spot size similar in dimension to the first spot size whereupon a distance between the fluid region and the other fluid region defines a pitch between the fluid region and the other fluid region; and

10. Perform other steps, include forming other spots on the substrate, as desired.

The above sequence of steps provides a method of forming spots using the present apparatus. The method can be used for form a high density array of spots for biological materials. Preferably, the spots have a dimension and characteristic to allow for the entire human genome, which could include at least 30,000 spots, depending upon the application. Further details of the method are provided with reference to the figure below.

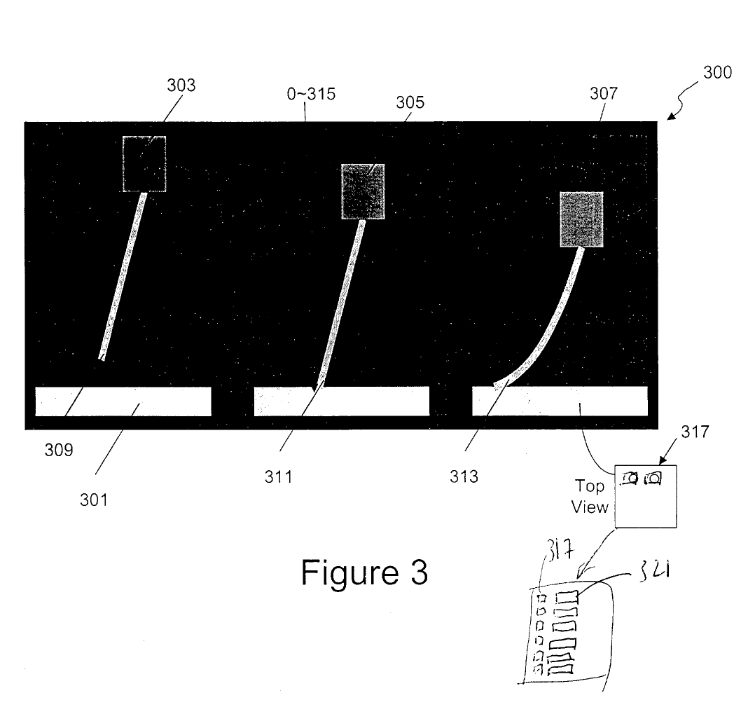

FIG. 3 illustrates simplified diagrams of a fluid dispensing method 300 according to an embodiment of the present invention. This diagram is merely an example, which should not unduly limit the scope of the claims herein. One of ordinary skill in the art would recognize many other variations, modifications, and alternatives. As shown, the method includes providing a dispensing apparatus 303, which has an elongated member having at least a trench region that extends from a first portion of the elongated member to an opening on a tip portion 309. The method applies the tip to a surface 301 of the substrate at an angle. The method maintains the angle 315 at ranges from about 20 to 30 degrees from a position normal to the surface of the substrate. To maintain contact with the surface, force is applied to the apparatus to flex 313 the tip portion as it makes contact with the surface of the substrate. As shown, the tip portion of the elongated member yields and acts as a spring to maintain the opening on the substrate to overcome any surface irregularities that may exist locally or from end to end on the substrate. Fluid is dispensed through the trench region that extends from the first portion of the elongated member to the opening at the tip to form a fluid region having a size of a dimension substantially equal to a width of the opening of the trench.

Next, the method lifts the tip from the surface of the substrate, where the tip including fluid in the tip is free from contact with the surface of the substrate. The tip is moved to another spatial region of the substrate and then applied at an angle from the substrate to from another fluid region having a spot size similar in dimension to the first spot size whereupon a distance between the fluid region and the other fluid region 317 defines a pitch between the fluid region and the other fluid region. Depending upon the application the fluid region 317 and also include other shapes or sizes 321. The present apparatus can be used to apply different spot sizes, which can be used for identification purposes. That is, the present method can be used to for spots of a first dimension, a second dimension, and an nth dimension, where n can be any number. Depending upon the application, the method performs other spots on the substrate, as desired, using one or more of the above techniques. Such method can be used to form a high density array of spots for biological materials. Preferably, the spots have a dimension and characteristic to allow for the entire human genome, which could include at least 30,000 spots, depending upon the application.

Optionally, the tip and apparatus are cleaned between applications of fluid. Here, the tip can apparatus including trench region are cleaned using water. The water can be purified or deionized, depending upon the application. The apparatus can also be subjected to a sonic force, such as ultrasonic, megasonic, or the like. The sonic force and water substantially removes any impurities from the tip, trench region, and apparatus for further applications. Additionally, the tip and apparatus can subjected to vacuum for evaporation of any liquid drops thereon, which are removed. Alternatively, the tip and apparatus, which are cleaned, are subjected to hot air or the like. Depending upon the embodiment, there can be many alternatives, modifications, and variations.

A method for fabricating a fluid dispensing apparatus is provided as follows:

1. Provide a substrate, which has an upper surface, a bottom surface, and a thickness defined there between;

2. Form a trench region within the substrate from the upper surface;

3. Pattern the bottom surface (or top or both simultaneously) of the substrate to define an elongated member, which has the trench region defined therein, from the substrate;

4. Maintain the trench region that extends from an upper portion to a lower portion of the elongated member along a length of the elongated member;

5. Etch a portion of the bottom surface to free the tip and substantially define the elongated member, while maintaining support of the elongated member via a support structure formed between the elongated member and an outer region of the substrate;

6. Coat a portion of the trench region including the opening with a hydrophilic material; and

7. Perform other steps, as desired.

The above steps provides a method for fabricating a fluid dispensing apparatus. The method includes a variety of steps, using conventional technologies. Such steps provide an easy way of manufacturing the apparatus for making high density arrays. Further details of these steps are provided below.

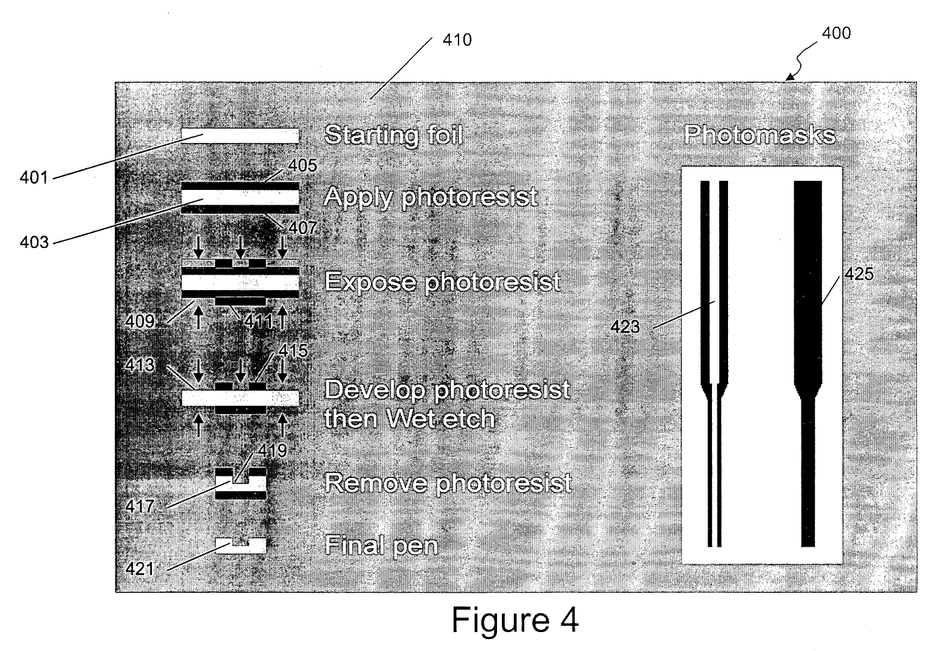

FIG. 4 illustrates methods 400 of fabricating a fluid dispensing apparatus according to an embodiment of the present invention. This diagram is merely an example, which should not unduly limit the scope of the claims herein. One of ordinary skill in the art would recognize many other variations, modifications, and alternatives. As shown, the method 410 includes providing a substrate 401, which has an upper surface, a bottom surface, and a thickness defined there between. Preferably, the thickness is 12.7 microns but can be less, depending upon the embodiment. The substrate is made of a suitable material such as metal, but can also be other materials. Preferably, the material is stainless steel and has characteristics of durability, flexibility, and is generally non-reactive.

The method includes patterning. Here, photo resist materials are formed on upper and lower surfaces 405, 407, respectively. The photoresist materials surround substrate 403, which is substrate 401. Preferably, the surfaces have substrate 401 have been cleaned via etching techniques, but can be others. Examples of such photo resist materials to form masks are provided as photomask 423 and photomask 425. Photomask 423 corresponds to the trench region, which also includes the shape of the elongated member. Photomask 425 corresponds to the elongated member, which will be applied to the bottom of the substrate. As shown, photo resist materials are exposed 411 to form patterns 409. Next, the materials are developed to form the hard mask, as shown.

Openings 413 in the mask are exposed to an etching environment 415, 419. The etching environment is provided on upper surface and lower surface. Depending upon the embodiment, various types of etchants and conditions can be used. The etching can be wet or dry or a combination of them. Preferably, etching is wet, using an aqua regia acid etchant for a stainless steel substrate. Etching continues until the elongated member 417 has been defined. Accordingly, the method forms the elongated member and the trench 419 during a portion of the same etching process, but can also be others. The photomask is stripped to form the final structure.

Depending upon the embodiment, the method also coats a portion of the trench region including the opening with a hydrophilic material. The hydrophilic material can be a polymer. Preferably, the material is urethane, but can be others. Additionally, the method can also use other techniques to form the elongated member such as laser ablation, etc., which is free from photomasks.

It is also understood that the examples and embodiments described herein are for illustrative purposes only and that various modifications or changes in light thereof will be suggested to persons skilled in the art and are to be included within the spirit and purview of this application and scope of the appended claims.

### EXPERIMENTS

To prove the principle and operation of the present invention, we performed various experiments. These experiments are merely examples, which should not unduly limit the scope of the claims herein. One of ordinary skill in the art would recognize many other variations, modifications, and alternatives. As merely an example, high resolution photolithography was used to form the present micromechanical devices. Such high resolution photolithography was performed by standard silicon fabrication technologies. Examples of conventional devices that used such photolithography included microelectromechanical device (MEMS) technologies (Petersen 1982). Other techniques included micro plating through lithographic masks, commonly referred to as the LIGA process (Becker et al. 1986), has also been widely used to define metal microstructures. LIGA relies upon metals electrodeposited through lithographically defined photo resist or x-ray resist masks and very high aspect ratio features can be achieved. Micro-electroplating of alloys, however, has often been difficult to control, and heat treatment of the resulting metal structures can be almost impossible. Thus alloys formed by typical LIGA processes suffer significant limitations in their mechanical properties, in particular resilience and tensile strength.

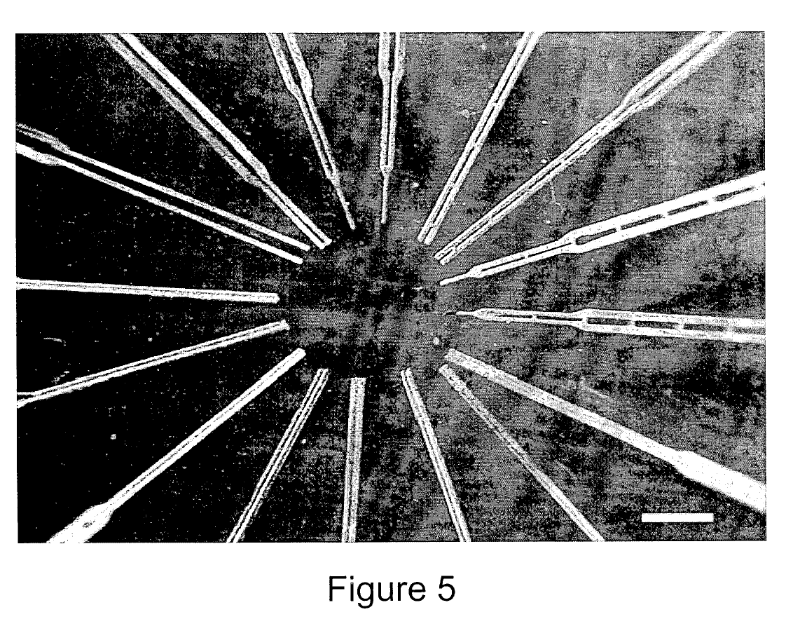

According to the present invention, we decided to use a different approach, which uses chemical or electrochemical etching of metals in a subtractive procedure, in which the photolithographic resist on the surface of the metal also serves as a chemically resistant etch mask. Such approach provides us with a very inexpensive and versatile technique to define arbitrary geometries into most metal alloys. We fabricated the pens from stainless steel foil using optical lithography. Photo masks were made with a 3386 dpi laser printer on standard overhead transparencies. The minimum line spacing on these masks is roughly 25 microns, but the foil was only 12.7 microns thick, allowing us to produce pens with a rectangular cross-section in which one dimension is extremely small. FIG. 5 shows a collection of pens of varying designs created using this technique, including features such as reservoirs and mechanical support struts. Conventional microarray pens work by capillary action, which requires that the length of the slot be greater than the width (Dreyer 1994). Since this was impossible to achieve with our printer resolution, we designed a different geometry in which the 2-walled slot was replaced with a 3-walled trench. When the pen is coated with hydrophilic urethane, the trench provides enough capillary action to trap the liquid. The unique design of this pen creates a surprising result: the total tip size is no longer the dominant property in determining the droplet size. Instead, the trench size determines the droplet width. The length of each rectangular droplet is controlled by an amount of pen flexure. The trench was etched to a depth of 6 microns in the 12.7 micron thick stainless steel. At the tip, the side walls of the trench are 30 microns wide and the trench itself has a width of 30 microns. Away from the tip, the trench width and the width of the side walls increase to 90 microns and 120 microns, respectively, to increase the sturdiness of the pen.

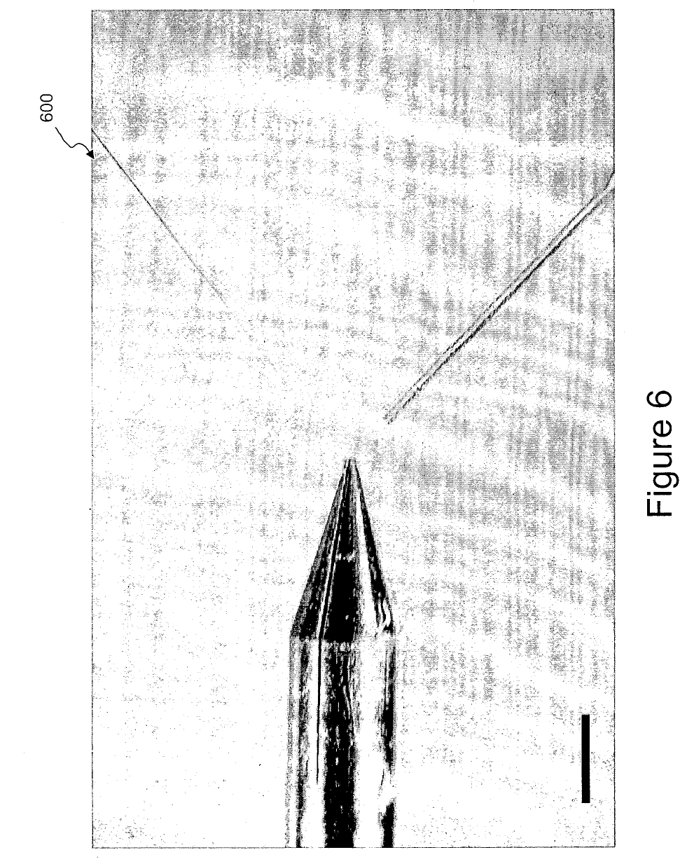

FIG. 6 shows a comparison of the micro fabricated trench pen with a conventionally machined slot pen. Higher resolution photo masks will allow further reduction of pen features. Indeed, smaller channel widths will increase capillation thus making the pens even more effective. Though delicate, there is no reason to expect mechanical failure of the pens during normal spotting or cleaning. Stainless steel is an excellent mechanical material and we have observed no plastic deformation from the slight deflections the pens undergo during printing and sonication for cleaning. When printing, the pens contact the printing surface at an angle of 20-30 degrees from perpendicular. Employing a non-perpendicular angle serves two purposes. First, this allows greater predictability of pen tip positioning due to the tip's flexion. Second, it serves as a way of crudely managing height variations in the slide, since the pen itself bends as a cantilever beam.

While certain conventional systems used springs as shock absorbers to manage height control, in this case the pen itself acts as a shock absorber. One benefit of this approach is that the pen does not dull; it bends but does not “break”. In the experiments described here, the pen deflects less than 5 percent of its length. A second result from using a flexible pen is the characteristic rectangular shape of the pen's footprints, which can be lengthened or shortened based on the amount of deflection.

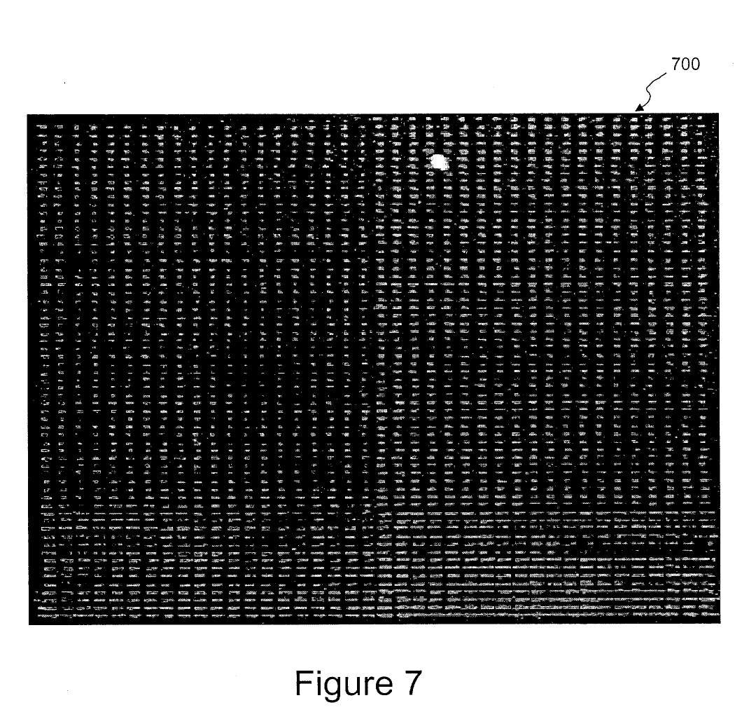

These pens were used to print arrays of fluorescent dye of up to 2500 spots with densities as high as 25,000 spots/cm². Such an array was produced in a 3.2 mm by 3.2 mm square (FIG. 7), suggesting slide capacities of about 75,000/150,000/225,000 spots when using 16/32/48 pens. (We assume the pens are spaced 4.5 mm apart to load from 384-well microtiter plates, and that each pen prints an independent block of spots roughly 4.4 mm on each side.) The variation in feature size in FIG. 7 is due primarily to expansion of spots after printing. Experiments indicate (data not shown) that a dry environment eliminates spot expansion, suggesting that improved uniformity could be achieved if the robotic array is fitted with a humidity-controlled chamber.

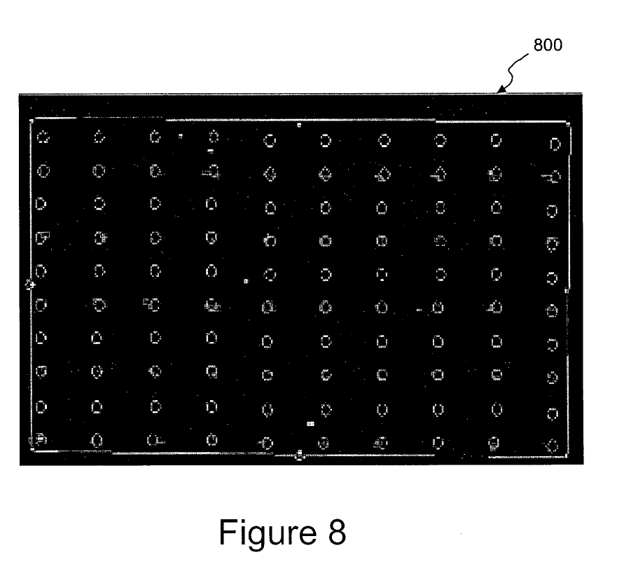

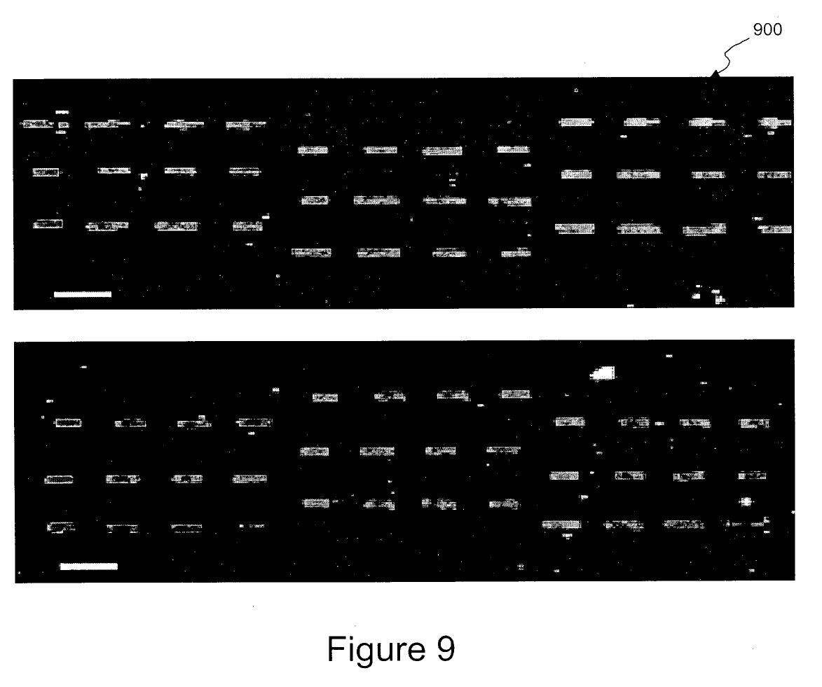

The highest density arrays printed with the trench pens had feature sizes of 20×40 microns. Lower density arrays were also produced, with rectangular feature sizes ranging from 20×80 to 30×140 microns. With careful tip cleaning, we observed negligible carryover when printing spots (FIG. 8). With a single loading, a pen could print on average 5-20 consecutive spots, depending on spot size and blotting conditions. Such spots can be provided on different substrates or up to 20 or so replicate spots on the same substrate. As array densities increase and spot sizes shrink, a concern is having enough material deposited to measure a signal. In order to prove that the printed arrays could be used to measure DNA hybridization, we spotted down two species of short DNA probes, and then hybridized fluorescently-labeled complementary oligonucleotides to them. The two different oligonucleotides were printed in blocks of 72 spots with a single micro fabricated pen. The blocks were printed with six rows of twelve spots. While printing each row, the pen was loaded prior to each group of four spots, alternating between the two probes on each load. Scans of arrays hybridized with Complement A showed successful binding only to Probe A. To further illustrate the success of the hybridization, the same slide was washed so as to remove the hybridized target DNA, and a second successful hybridization was performed with Complement B (FIG. 9).

These results demonstrate that micro fabricated fountain pens are capable of depositing consistently small features that may be used in DNA hybridization experiments with low amounts of carryover and non-specific binding. These pens can be mass-produced cheaply because the material is inexpensive and the photolithography process allows parallel production. Higher resolution lithography will permit the fabrication of pens that print smaller features while storing larger amounts of fluid. This will lead to higher density DNA arrays, allowing one to measure full genome gene expression of humans and mice with a single array, among other entities. Finally, increased feature density should improve array sensitivity by reducing the area available for non-specific binding and by decreasing the surface area a target molecule must diffuse over.

Pens were fabricated by using a two-exposure procedure to define a pattern into 12.7 micron thick 300 series stainless steel shim stock sheets. During the lithographic exposure, the metal sheet is lithographically patterned from both the front and the back surface, and subsequently etched from both sides. Masks for the front and back of the pen were designed on Adobe Photoshop, and then printed onto transparencies using a 3386 dpi laser printer, cut out and individually secured by their edges to glass plates with scotch tape. The masks were designed to be larger than the stainless steel shim-stock sheets from which the pens were etched.

Moreover, alignment marks were defined in mask areas that extended beyond the stainless steel sample edges. The stainless steel sheets were spin-coated with thin layers of Microposit S1818 photo resist on both sides, and a soft-bake was performed at 90° C. for 10 minutes on each side. The foil was then cut into smaller pieces, each of which would ultimately become a separate set of pens. These smaller pieces were then attached to a back mask (Mask #1) transparency with scotch tape, and exposed with a front mask pattern (Mask #2) in a Carl Suss MJB-3 contact mask aligner. The front mask (Mask #2) pattern, which is used for the initial exposure, was registered to the back mask pattern (onto which the sample was attached) by using the alignment marks from the back mask which were defined beyond the edges of the stainless steel shim stock pieces. In the second photolithography step, the sample was turned over and exposed from the rear with the attached back mask (Mask #1) pattern. By using this method, the front and rear of the shim stock could be lithographically patterned with very accurate aligned features.

By performing lithography on both sides of the shim stock, it was possible to etch through the 12.7 micron thick steel layer in a single chemical etch, and it was also possible to define slightly different features on the front and back of the shim stock sample. After both exposures were completed, the sample was developed in a Microposit CD-30 developer, followed by a 140° C. hardbake for 15 minutes. The photo resist masked stainless steel shim stock was subsequently immersed into a mixture of 40 volume % HCl:40 volume % H₂O:20 volume % HNO₃, 10 which removed the unmasked areas of stainless steel. During the etch, the sample was gently shaken in the solution to avoid gas bubble formation on the steel surface and to ensure a uniformly etched surface. The etch time was typically eight to ten minutes, or until excess steel was completely separated from the pen's base. The pens were finally cleaned in baths of acetone, isopropyl alcohol, and distilled water. Low power ultrasonic cleaning was used to completely remove the photo resist mask layer, and the pens were dipped into a thinned urethane solution (1 part Ebecryl CL 1039 Acrylated Urethane:1 part ethyl alcohol:1% Irgacure 500), and then inverted and exposed in a UV curing oven for 10 minutes. At this point, the pens were ready for use.

Arrays were printed by affixing them to a homemade robotic array constructed according to the design of Brown et al. (Schena et al. 1995). Custom control software was written in order to improve precision of the arrayed spots. Average error was reduced from 41.6 to 13.6 microns by introducing a zeroing algorithm to make use of the more accurate positional repeatability of the motors as opposed to the positional accuracy that is used in the Stanford software. The remaining error is due largely to the use of two motor slides for the x and y axes, each with comparable errors. The software developed introduced functions that allowed us to better study printing dynamics as well as giving greater flexibility over printing parameters including independent row/column spacing, introduction of test print algorithms to calibrate slides quickly, easier positional control of multiple block placements done in several prints on a single slide, alternating printing between arbitrary wells, and the replacement of the vacuum station 11 with a heat reservoir. The code was written in Visual Basic 5.0 using ActiveX controls from Galil Motion Control. Both its source and executable code are available on the web at http://thebigone.caltech.edu/genomics/arrayer/software.html.

The cleaning process consists of two stations: a sonication wash station and a drying station. The sonicator used was a Koh-I-Noor Ultrasonic Cleaner 25K42. The drying station was converted from the original Stanford vacuum station to a heat reservoir. The heat reservoir was constructed of two nested aluminum sheet metal boxes separated by an insulating layer of glass wool. The heat was produced by a heat gun on its low setting, delivered through a hole in the side of the reservoir and deflected upwards by an internal shield. Pens dip into the reservoir through the top. The reservoir was preheated for one minute before a print commenced and was reheated during each sonication. The heat reservoir was measured to maintain temperatures of ˜150° C. consistently. Sonication and dry times of six and five seconds respectively were found sufficient with two cleaning cycles on each reload.

### Slide Calibration Protocol

Considering that microscope slides may vary in thickness between slides by as much as 500 microns, and on a single slide itself by 10's of microns, we established tip-slide distance calibration using a special algorithm written into the robot control software. This allowed the user to specify a maximum contact distance and then incrementally step this distance on each successive print, reducing contact between the pen and slide. Thus, a block could quickly be produced in which spot sizes would vary (not shown), from which appropriate contact settings could quickly be established. This was typically done with a solution of either fluorescein or xylene cyanol FF. This step will not be necessary for arrayers that measure the distance to the slide surface.

### Hybridization Protocol

Oligonucleotide probes were synthesized at the Caltech Biopolymer Synthesis and Analysis Resource Center with the following sequences: 5′-AACCCCACAA-s-a (Probe A); and 5′-ACAACCCAAA-s-a (Probe B). “s” indicates the C12 Spacer Phosphoramidite, and “a” indicates the C7 Amino Modifier, both from Glen Research, Sterling, Va. The complementary fluorescent targets had the sequences: 5′TTGTGGGGTT-Cy3-A (Complement A) and 5-TTTGGGTTGT-Cy3-A (Complement B). Probes were printed onto ArrayIt™ Silylated Slides in a printing solution having 5×SSC, 0.001% SDS (sodium dodecyl sulfate), and 50 μM DNA. The slides were then left to dry at room temperature for 24 hours, and subsequently washed and blocked according to the slide manufacturer's recommended protocol, which was modified by extending all wash steps to 5 minutes duration. Prior to hybridization, the slides were incubated at 37° C. with a solution of 5×SSC, 0.1% SDS, and 10 mg/mL BSA (bovine serum albumin) to reduce background due to non-specific binding. A separate hybridization solution was prepared for each target oligonucleotide since they are labeled with the same fluorophore: 4×SSC, 0.05% SDS, 0.2 mg/mL BSA, and 0.16 μM DNA. Hybridizations were carried out under a cover slip, at a temperature of 15° C. for 2 hours. Subsequently, slides were washed in a series of four solutions (W1, W2, W3, W4) for 5 min. each. W1 (1×SSC, 0.03% SDS, ≈9° C.); W2 (0.2×SSC, ≈11° C.); W3 (0.05×SSC, ≈13° C.); W4 (H₂O, ≈15° C.). The ramping temperature was achieved by refrigerating plastic test tubes containing 50 mL of each wash solution to ≈9° C., then performing the entire wash sequence with all tubes exposed to room temperature. Washed slides were dried with nitrogen and scanned immediately on a GenePix 4000A micro array scanner.

It is also understood that the examples and embodiments described herein are for illustrative purposes only and that various modifications or changes in light thereof will be suggested to persons skilled in the art and are to be included within the spirit and purview of this application and scope of the appended claims.

### References

Alizadeh A. A. et al. 2000. Distinct types of diffuse large B-cell lymphoma identified by gene expression profiling. Nature 403: 503-510.

Becker E. W., Ehrfeld W., Hagmann P., Maner A., MŸnchmeyer D. 1986. Fabrication of Microstructures with High Aspect Ratios and Great Structural Heights by Synchrotron Radiation Lithography, Galvanoformung, and Plastic Moulding (LIGA Process). Microelectronic Engineering, 4: 35-56.

Chu S. et al. 1998. The transcriptional program of sporulation in budding yeast. Science 282: 699-705.

DeRisi J. L., Iyer V. R., Brown P. O. 1997. Exploring the Metabolic and Genetic Control of Gene Expression on a Genomic Scale. Science 278: 680-686.

Dreyer M., Delgado A., Rath H-J. 1994. Capillary Rise of Liquid between Parallel Plates under Microgravity. Journal of Colloid and Interface Science, 163: 158-168.

Dziurdzia B., Nowak S., Cie\dot{z}, M., Gregorczyk, W. 2000. Metal Foil Screens—Manufacturing and Techniques of Printing. Proceedings of the XVII Conference of the International Microelectronics and Packaging Society, Poland.

Golub T. R. et al. 1999. Molecular classification of cancer: class discovery and class prediction by gene expression monitoring. Science 286: 531-537.

Jin W., Riley R. M., Wolfinger R. D., White K. P., Passador-Gurgel G., Gibson G. 2001. The contributions of sex, genotype and age to transcriptional variance in Drosophila melanogaster. Nature Genetics 29: 389-395.

Lipshutz R. J et. al. 1999. High Density Synthetic Oligonucleotide Arrays. Nature Genetics 21: 20-24.

Lockhart D. J., Winzeler E. A. 2000. Genomics, gene expression and DNA arrays. Nature 405: 827-836.

Matson D. W. et al. 1999. Fabrication of Microchannel Chemical Reactors Using a Metal Lamination Process. Proceedings of the 3^{rd} International Conference on Microreaction Technology, Frankfurt, Germany.

Okamoto T., Suzuki T., Yamamoto N. 2000. Microarray fabrication with covalent attachment of DNA using Bubble Jet technology. Nature Biotechnology 18: 438-441.

Petersen, K. E. 1982. Silicon as a Mechanical Material. Proceedings of the IEEE. 70(5): 420-457.

Reese, Matthew. 2001. Microfluidic Fountain Pens. Undergraduate thesis, California Institute of Technology, Pasadena, Calif.

Schena M., Shalon D., Davis R. W., Brown P. O. 1995. Quantitative monitoring of gene-expression patterns with a complementary-DNA microarrays. Science, 270(5235): 467-470.

Shoemaker D. D. et al. 2001. Experimental annotation of the human genome using microarray technology. Nature 409: 922-927.

### Web Site References

http://www.affymetrix.con/support/technical/datasheet/hgu133_datasheet.pdf, GeneChip® Human Genome U133 Set.

http://www.majerprecision.com/pins.htm, Majer Precision MicroQuill® Array Pins.

http://arrayit.com/Products/Printing/Stealth/stealth.html, Stealth Micro Spotting Device.

http://www.biorobotics.con/Pages/micspot.html, BioRobotics' MicroSpot.

http://thebigone.caltech.edu/genomics/arrayer/software.html, Caltech MicroArrayer, Matthew Reese.

What is claimed is:

1. A fluid dispensing system for biological applications, the dispensing system including a fluid dispensing apparatus for applying selected fluids in a predetermined manner to form a plurality of spots based upon one or more of the selected fluids on a surface of a substrate, the apparatus comprising;
an elongated member having at least a tip portion, the tip portion extending from the elongated member;
an etched trench extending along a portion of a length of the elongated member to the tip to form an opening defined on the tip portion and coupled to the etched trench;
a flexible region defined within the elongated member to allow the tip to adjust in position upon contact with the surface of the substrate; and
a fluid disposed within the etched trench, the fluid being output through the opening on the tip to form one or more than one spots on the surface of the substrate.

2. The apparatus of claim 1 wherein the etched trench has a width of 30 microns and less.

3. The apparatus of claim 1 wherein the elongated member comprises stainless steel to allow the tip to adjust in position upon contact with the surface of the substrate.

4. The apparatus of claim 1 wherein the depth of the trench is about 6 microns and less and the elongated member has a thickness of less than 13 microns from an upper region to a lower region.

5. The apparatus of claim 1 wherein the etched trench comprises a hydrophilic coating overlying exposed surfaces of the etched trench to enhance capillary action.

6. The apparatus of claim 1 wherein the etched trench comprises an overlying layer of urethane.

7. The apparatus of claim 1 wherein the tip being a continuous region with a positive annular region to form the opening.

8. The apparatus of claim 1 further comprising an upper region extending from the trench region, the upper region having a larger volume than a volume of the trench region to store the fluid.

9. The apparatus of claim 1 wherein the flexible region is free from movement before contact with the surface of the substrate.

10. The apparatus of claim 1 wherein the fluid comprises a salt, a surfactant, and a biological material.

11. The apparatus of claim 1 wherein the etched trench includes an overlying hydrophobic layer in contact with the fluid.

12. The apparatus of claim 1 wherein the tip flexes and moves in a lateral manner on the surface of the substrate to adjust in position to form substantial continuous contact with the surface having a surface roughness of at least ten microns when force has been applied to the tip toward the surface of the substrate.

13. A method for forming a high density array of spots on a substrate for biological applications, the method comprising:
providing a dispensing apparatus, the dispensing apparatus comprising an elongated member having at least a trench region that extends from a first portion of the elongated member to an opening on a tip portion;
applying the tip to a surface of the substrate at an angle whereupon the angle ranges from a position normal to the surface of the substrate; and
dispensing fluid through the trench region that extends from the first portion of the elongated member to the opening at the tip to form a fluid region having a size of a dimension substantially equal to a width of the opening of the trench.

14. The method of claim 13 wherein the angle ranges from about 20 to 30 degrees from the position normal to the surface of the substrate.

15. The method of claim 13 further comprising lifting the tip from the surface of the substrate; moving the tip to another spatial region of the substrate; and applying the tip at an angle to the substrate to form another fluid region having a spot size similar in dimension to the first spot size whereupon a distance between the fluid region and the other fluid region defines a pitch between the fluid region and the other fluid region.

16. The method of claim 13 wherein the pitch is 75 micron and less in at least one dimension.

17. The method of claim 13 wherein the size is 30 microns and less in at least one dimension.

18. The method of claim 13 further comprising repeating the applying and dispensing to form one or more other spots on other spatial surface regions of the substrate.

19. A method for manufacturing a fountain pen dispenser for biological applications, the method comprising:
providing a substrate, the substrate having an upper surface, a bottom surface, and a thickness defined there between;
forming a trench region within the substrate from the upper surface, the trench region having a length and a width;
patterning at least the bottom surface of the substrate to define an elongated member from the substrate, the elongated member having the trench region defined therein, whereupon the trench region extends from an upper portion to a lower portion of the elongated member along a length of the elongated member;
etching to free the tip and substantially define the elongated member; and
coating a portion of the trench region including the opening with a hydrophilic material.

20. The method of claim 19 wherein the etching is isotropic.

21. The method of claim 19 wherein the etching is wet etching.

22. The method of claim 19 wherein the trench includes rounded edges.

23. The method of claim 19 wherein the etching is dry etching.

24. The method of claim 19 wherein the patterning includes simultaneously patterning the upper surface to form the elongated member.

25. The method of claim 19 wherein the substrate includes a plurality of elongated members.

26. The method of claim 19 wherein the plurality of elongated members are coupled to each other along a side.

27. The method of claim 19 further comprising releasing the elongated member by removing at least the support structure.

28. A biological array of spots having a quantity to map a complete genome on a single substrate, the biological array comprising:
a substrate including a surface and a thickness, the surface having a hydrophilic surface, the surface having a surface dimension variation from a first end to a second end;
at least 30,000 spots provided on a surface of the substrate, each of the spots being placed in a spatial manner based upon a predetermined order;
wherein the complete human genome is provided on the single substrate to reduce a possibility of variation between the substrate and another substrate.

29. The array of claim 28 wherein substrate is 1 by 3 inch slide.

30. The array of claim 28 wherein the array of spots are provided 18 by 72 millimeters.

31. The array of claim 28 wherein the single substrate is a conventional glass side or a plurality of glass slides.

32. The array of claim 28 wherein the spot density is 5000 genes per square centimeter or greater.

33. A method for manufacturing a fountain pen dispenser, the method comprising:
providing a substrate, the substrate having a top surface, a bottom surface, and a thickness defined between the top surface and bottom surface;
patterning the top surface of the substrate to define a trench region having a length and width; and
forming an elongated member having the trench region defined therein from the substrate, the elongated member having a tip portion coupled to an opening of the trench region.

34. The method of claim 33 further comprising coating a portion of the trench region with a hydrophilic material.

35. The method of claim 33 wherein the forming comprises patterning the top surface and the bottom surface of the substrate simultaneously.

36. The method of claim 33 wherein the forming comprises patterning only the top surface.

37. The method of claim 33 wherein the forming comprises patterning only the bottom surface.
